(19) United States
(12) Patent Application Publication
(10) Pub. No.: US 2025/0314796 A1
(43) Pub. Date: Oct. 9, 2025

(54) METHODS AND SYSTEMS TO GENERATE COMPONENTS OF THE DIRECTIONAL GRADIENT OF THE SEISMIC WAVEFIELD

(71) Applicant: Schlumberger Technology Corporation, Sugar Land, TX (US)

(72) Inventors: Massimiliano Vassallo, Crawley (GB); Rajiv Kumar, Crawley (GB); Richard Bisley, Perth (AU); Alexander Zarkhidze, Crawley (GB); Andrea Lovatini, London (GB)

(21) Appl. No.: 19/172,732

(22) Filed: Apr. 8, 2025

Related U.S. Application Data
(60) Provisional application No. 63/631,601, filed on Apr. 9, 2024.

(51) Int. Cl. G01V 1/50; G01V 1/00

(52) U.S. Cl. CPC G01V 1/50; G01V 1/003; G01V 2210/6169; G01V 2210/675; G01V 2210/74

(57) ABSTRACT

System and method operable to estimate directional gradients of a seismic wavefield from seismic data from a seismic survey. The operations include receiving the seismic data describing the seismic wavefield, estimating the directional gradients, from the seismic data, of the seismic wavefield along one or more directions, using the seismic wavefield and the directional gradients to perform an action, creating interpolated data using the seismic wavefield and the directional gradients for interpolation, identifying a subset of the interpolated data based on pre-selected criteria, determining residual data based on a difference between the subset and the seismic wavefield, estimating the directional gradients from the residual data, and displaying the directional gradients.

### CROSS REFERENCE TO RELATED APPLICATIONS

This patent application claims priority to U.S. Provisional Application No. 63/631,601, filed on Apr. 9, 2024, which is incorporated by reference herein in its entirety.

### BACKGROUND

In towed streamers marine acquisitions, in addition to the pressure wavefields, modern receiver technology can measure the particle motion of the pressure wavefields, which describes the gradient of the pressure wavefield. While this technology exists, it typically involves considerably higher cost with respect to alternatives that do not measure the horizontal components of particle motion or gradients at receivers. In practice, in the industry of towed streamer marine acquisitions, the majority of measuring devices in use do not have the ability to measure the horizontal particle motion or gradient. What is needed is a system that estimates the horizontal gradients for data collected using technologies that do not measure the horizontal particle motion.

In ocean bottom seismics, typically the pressure wavefield and the three components of particle motion are measured, but particle motion measured at the water-bottom is not a direct measure of the gradient of the pressure, for well-known physical reasons. While advanced processing technologies can be used to convert the particle motions at seabed into the gradient of the pressure, these require the knowledge of the properties of the near-surface formations and a well-sampled wavefield. In this scenario, the ability to estimate the horizontal gradient from the hydrophone measurements could be beneficial.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a non-transitory computer-readable medium storing instructions that to perform operations operable to estimate directional gradients of a seismic wavefield from seismic data from a seismic survey. The operations include receiving the seismic data describing the seismic wavefield, where the seismic data include land seismic, towed steamer measurements, ocean bottom cables measurements, ocean bottom nodes measurements, and the seismic data at intermediate stages of seismic processing flows. estimating the directional gradients, from the seismic data, of the seismic wavefield along one or more directions, where estimating the directional gradients may include estimating slowness based on a time derivative of the seismic wavefield, where estimating the slowness may include pre-processing the seismic wavefield using any one of time-derivative/gradient ratio, resolving an inverse problem, or plane wave destruction filters, where pre-processing the seismic wavefield may include any one of applying a fan filter in inline to the seismic wavefield, transforming in a sparsity promoting domain, applying a low pass filter to the seismic wavefield, or applying a crossline interpretation to the seismic wavefield. The operations include using the seismic wavefield and the directional gradients to perform an action, where the action may include any one or more of interpolation or full waveform inversion using the seismic wavefield and the directional gradients, where the interpolation may include any one of MIMAP or MC interpretation, where the one or more directions may include any one of inline source or crossline source in ocean bottom node/towed streamer/land, or any one of inline receiver or crossline receiver in ocean bottom node/towed streamer/land, or any one of inline offset or crossline offset, or any one of inline midpoint or crossline midpoint, or any one of depth model space and intermediate domain during processing, where the action may include designing the seismic survey, or reprocessing historical seismic data. The operations include creating interpolated data using the seismic wavefield and the directional gradients for interpolation, identifying a subset of the interpolated data based on pre-selected criteria, determining residual data based on a difference between the subset and the seismic wavefield, estimating the directional gradients from the residual data, and displaying the directional gradients. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment in accordance with embodiments of the present disclosure.

FIGS. 2-5 illustrate schematic views of an oilfield having subterranean formation containing reservoir therein in accordance with embodiments of the present disclosure.

FIG. 6 illustrates a schematic view, partially in cross section of oilfield having data acquisition tools illustrates a schematic view, partially in cross section of oilfield in accordance with embodiments of the present disclosure.

FIG. 7 illustrates an oilfield for performing production operations in accordance with embodiments of the present disclosure.

FIG. 8 illustrates the component(s) of the seismic waves that may be reflected and converted by the seafloor surface and seismic wave reflections, and may be received by a plurality of seismic receivers.

FIG. 9 illustrates a marine electromagnetic survey system in accordance with embodiments of the present disclosure.

FIG. 10 illustrates a seismic system in accordance with embodiments of the present disclosure in which a plurality of tow vessels enables seismic profiling.

FIGS. 11A-11J are flowcharts of methods in accordance with embodiments of the present disclosure.

FIG. 12A illustrates an example of the algorithm applied to data obtained by filtering seismic synthetic in a narrow angular range.

FIG. 12B illustrates an example of the algorithm applied to data obtained by filtering seismic synthetic in a different angular range from the illustration in FIG. 12A.

FIG. 12C illustrates a modelled space derivative of synthetic seismic data (left panel), and an estimated space derivative of synthetic data, calculated using an algorithm in accordance with embodiments of the present disclosure.

FIG. 13 illustrates a schematic view of a computing system for performing at least a portion of the method(s) herein in accordance with embodiments of the present disclosure.

FIG. 14 is a flowchart of a method in accordance with embodiments of the present disclosure.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

A system and method in accordance with embodiments of the present disclosure use the measurements of pressure wavefields generated by traditional sources or other types of sources such as, for example, but not limited to, marine vibrators and other technologies, to estimate the wavefield of the directional pressure gradient in the source direction. The system and method use seismic data to estimate one or more directional components of the gradient of the pressure in the spatial dimensions of the source coordinates during seismic surveys. In marine scenarios (towed streamer or ocean bottom seismic), a physical wavefield describing the gradient of the pressure on the source side cannot be generated with standard seismic source devices (that could be referred as monopole sources, or combinations of arrays of monopole sources).

The system and method can generate the gradient of the pressure in the spatial dimensions of the source coordinates, either measured (particle motion wavefield) or generated through processing (upgoing/downgoing pressure, primary reflections, Green functions, or others). The system and method can also be used in a wider range of dimensions, not limited to the source coordinates. The system and method enable estimating directional gradients when the sampling along the direction of interest is not dense enough for a traditional gradient operator to work. Once obtained, the directional gradient can enable multi-channel interpolation of the main wavefield in the source domain.

In marine scenarios, multi-channel interpolation of seismic sources can enable surveys to have flexibility over the density of the carpet of seismic sources to be deployed, resulting in improvements in surveys in the field, including improved cost and environmental footprint. In marine scenarios, one or more seismic source devices are towed by a vessel and shot while the vessel sails along pre-design paths, called source lines. Reducing the density of source lines can reduce the cost and the environmental impact of the acquisition.

Multi-channel interpolation can improve surveys acquired with standard geometry by enabling a fine resolution of the answer products. This can enable reprocessing legacy data acquired with standard geometries and processed assuming the crossline source dimension was under-sampled.

The system and method use low frequency signals to calculate local directional slownesses, for example, by using a time-derivative/gradient ratio or plane destruction filters. Directional gradients of input measurements are calculated based on local directional slownesses and input measurements. The crossline gradient can be used to enable multi-channel interpolation across seismic source lines. The system and method can be used to calculate the gradients of wavefields in other domains and from other types of survey, such as, for example, but not limited to, ocean bottom seismic receivers, land seismic sources and/or receivers, and distributed acoustic sensing sources and/or receivers. The descriptions of the system and method refer to the dimension of the crossline coordinate of the source. The system and method can work in any other dimension in the acquisition system, for example, inline source, inline and crossline receivers, offset, and midpoint, or on any other domain domains that characterize steps of seismic processing, for example, multiple model, depth model, and velocity model.

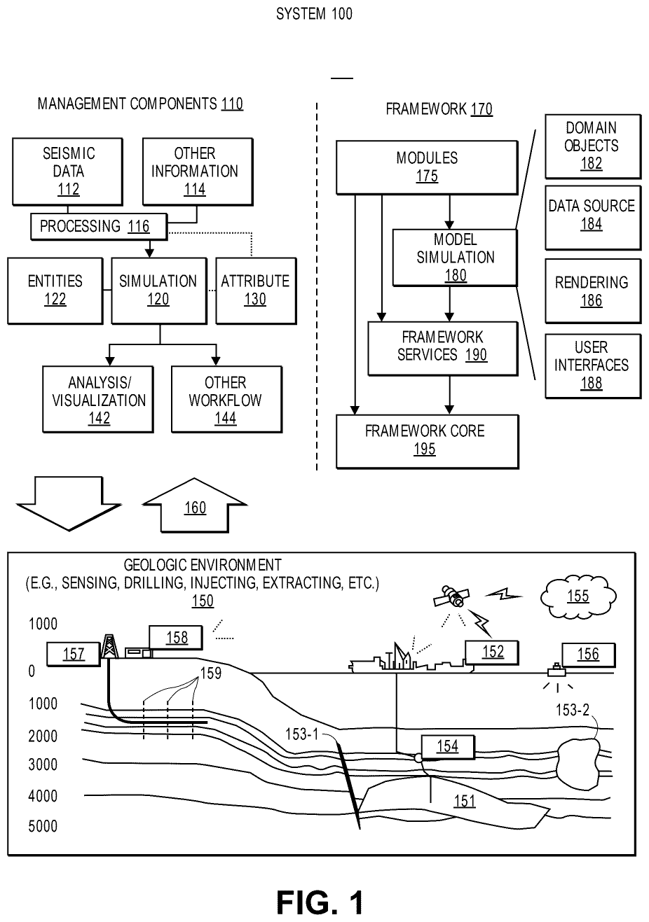

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 144 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 144 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

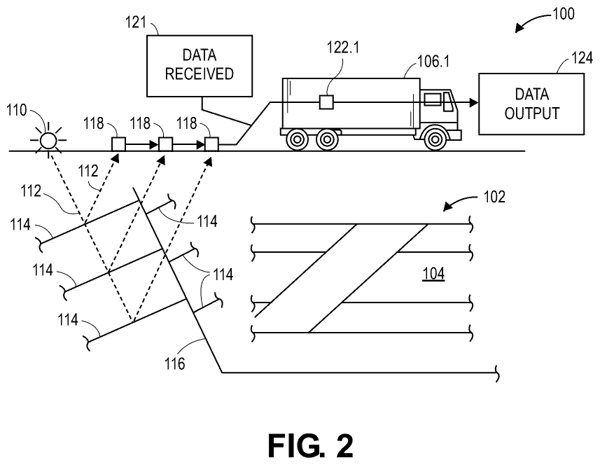

Referring now to FIG. 2, illustrated is a survey operation being performed by a survey tool, such as seismic truck 106.1, to measure properties of the subterranean formation. The survey operation is a seismic survey operation for producing sound vibrations. In FIG. 2, one such sound vibration, e.g., sound vibration 112 generated by source 110, reflects off horizons 114 in earth formation 116. A set of sound vibrations is received by sensors, such as geophone-receivers 118, situated on the earth's surface. The data received are provided as input data to a computer 122.1 of a seismic truck 106.1, and responsive to the input data, computer 122.1 generates seismic data output 124. This seismic data output may be stored, transmitted or further processed as desired, for example, by data reduction.

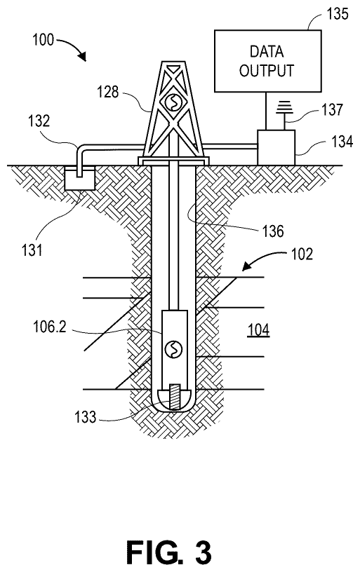

Referring now to FIG. 3, illustrated is a drilling operation being performed by drilling tools 106.2 suspended by rig 128 and advanced into subterranean formations 102 to form wellbore 136. A mud pit is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors, such as gauges, may be positioned about oilfield to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors may be collected by surface unit 134 and/or other data collection sources for analysis or other processing. The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield or other locations. Surface unit 134 may also be provided with or functionally connected to one or more controllers (not shown) for actuating mechanisms at oilfield. Surface unit 134 may then send command signals to oilfield in response to data received. Surface unit 134 may receive commands via transceiver 137 or may itself execute commands to the controller. A processor may be provided to analyze the data (locally or remotely), make the decisions and/or actuate the controller. In this manner, oilfield may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

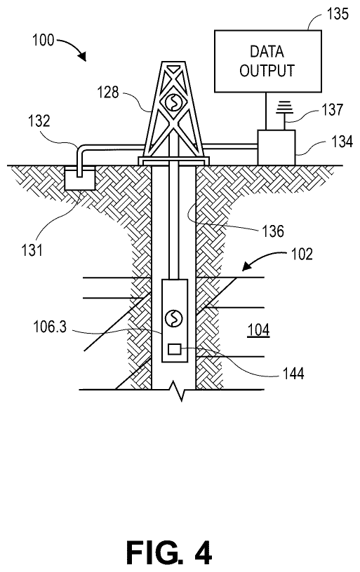

Referring now to FIG. 4, illustrated is a wireline operation being performed by wireline tool 106.3 suspended by rig 128 and into wellbore 136 of FIG. 3. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors, such as gauges, may be positioned about oilfield to collect data relating to various field operations as described previously. As shown, a sensor is positioned in wireline tool 106.3 to measure downhole parameters which relate to, for example porosity, permeability, fluid composition and/or other parameters of the field operation.

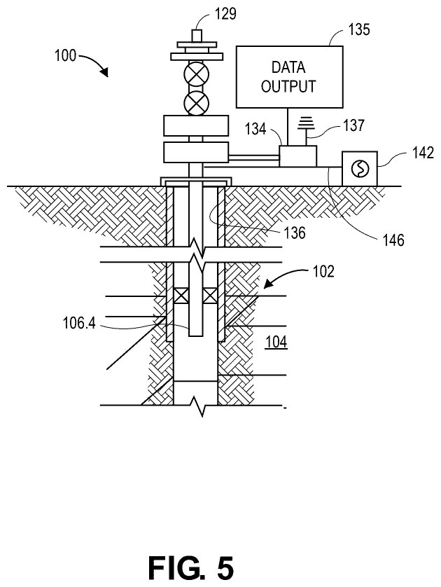

Referring now to FIG. 5, illustrated is a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors, such as gauges, may be positioned about oilfield to collect data relating to various field operations as described previously. As shown, the sensor may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

FIGS. 3-5 illustrate tools used to measure properties of an oilfield. It will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors may be located at various positions along the wellbore and/or the monitoring tools to collect and/or monitor the desired data. Other sources of data may also be provided from offsite locations.

The field configurations of FIGS. 2-5 are intended to provide a brief description of an example of a field usable with oilfield application frameworks. Part of, or the entirety, of oilfield may be on land, water, and/or sea. Also, while a single field measured at a single location is depicted, oilfield applications may be utilized with any combination of one or more oilfields, one or more processing facilities and one or more wellsites.

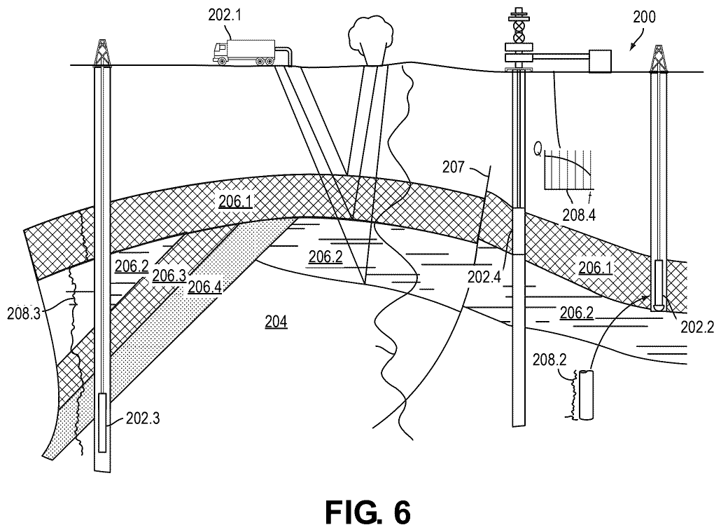

FIG. 6 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2-5, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 6, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

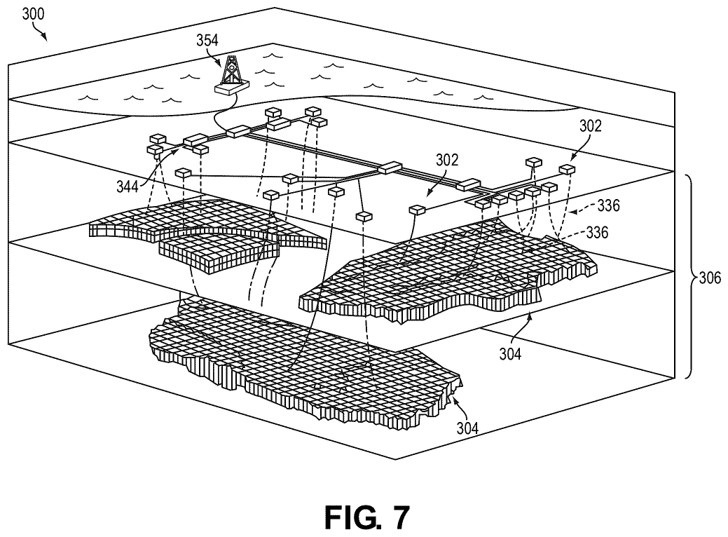

FIG. 7 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 0G is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

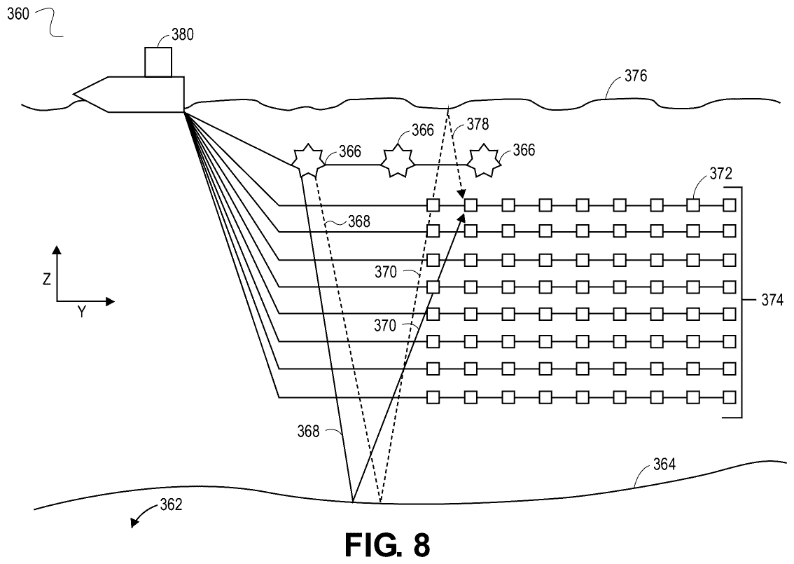

FIG. 8 illustrates the component(s) of the seismic waves 368 that may be reflected and converted by the seafloor surface 364 (i.e., reflector) and seismic wave reflections 370, and may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Typically, marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 0H illustrates eight streamers towed by vessel 380 at eight different depths. The depth of each streamer may be controlled and maintained using the birds disposed on each streamer.

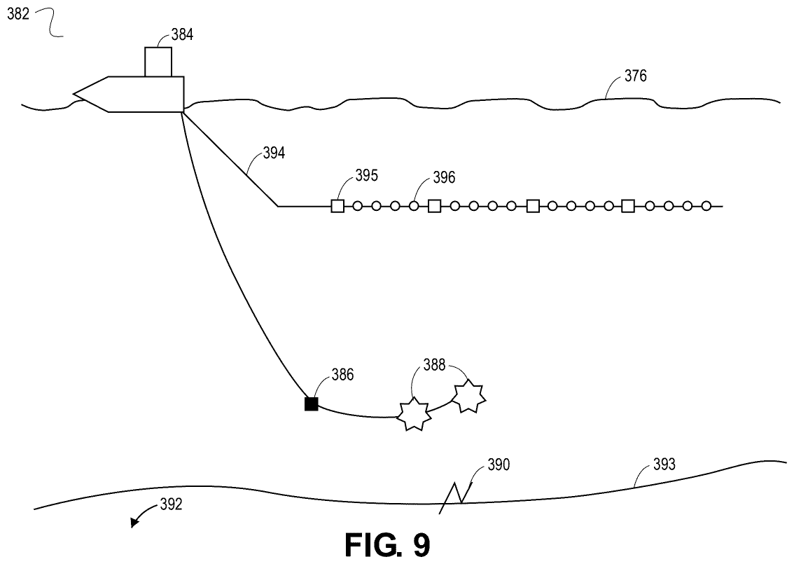

FIG. 9 illustrates a marine electromagnetic survey system 382 in accordance with implementations of various technologies described herein. The electromagnetic survey system 382 may use controlled-source electromagnetic (CSEM) survey techniques, but other electromagnetic survey techniques may also be used. Marine electromagnetic surveying may be performed by a survey vessel 384 that moves in a predetermined pattern along the surface 385 of a body of water such as a lake or the ocean. The survey vessel 384 is configured to pull a towfish (an electric source) 386, which is connected to a pair of electrodes 388. During the survey, the vessel may stop and remain stationary for a period of time while obtaining measurements, while in some circumstances, the vessel may remain underway while obtaining measurements.

At the source 386, a controlled electric current may be generated and sent through the electrodes 388 into the seawater. For instance, the electric current generated may be in the range between about 0.01 Hz and about 20 Hz. The current creates an electromagnetic field 390 in the subsurface 392 to be surveyed below the sea floor 393. The electromagnetic field 390 may also be generated by magneto-telluric currents instead of the source 386. The survey vessel 384 may also be configured to tow a sensor cable 394. The sensor cable 394 may be a marine towed cable. The sensor cable 394 may contain sensor housings 395, telemetry units 396, and current sensor electrodes (not illustrated). The sensor housings 395 may contain voltage potential electrodes for measuring the electromagnetic field 390 strength created in the subsurface area 392 during the surveying period. The current sensor electrodes may be used to measure electric field strength in directions transverse to the direction of the sensor cable 394 (the y- and z-directions). The telemetry units 396 may contain circuitry configured to determine the electric field strength using the electric current measurements made by the current sensor electrodes. While a marine-based electromagnetic survey is described in regard to FIG. 0H-E, a land-based electromagnetic survey may also be used in accordance with implementations of various techniques described herein.

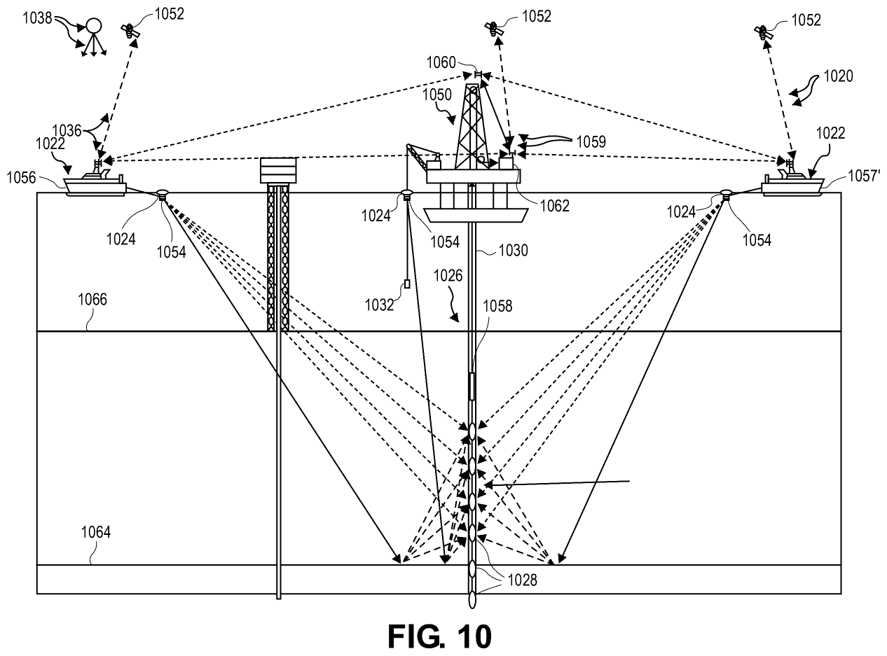

FIG. 10 illustrates an embodiment of seismic system 1020 in which a plurality of tow vessels 1022 is employed to enable seismic profiling, e.g., three-dimensional vertical seismic profiling or rig/offset vertical seismic profiling. In FIG. 10, a marine system is illustrated as including a rig 1050, a plurality of vessels 1022, and one or more acoustic receivers 1028. Although a marine system is illustrated, other embodiments of the disclosure may not be limited to this example. A person of ordinary skill in the art will recognize that teachings of the disclosure may be used in land or offshore systems. However, offshore systems are described herein to simplify the disclosure and to facilitate explanation.

Although two vessels 1022 are illustrated in FIG. 10, a single vessel 1022 with multiple source arrays 1024 or multiple vessels 1022 each with single or multiple sources 1024 may be used. In some applications, at least one source/source array 1024 may be located on the rig 1050 as represented by the rig source in FIG. 10. As the vessels 1022 travel on predetermined or systematic paths, their locations may be recorded through the use of navigation system 1036. In some cases, the navigation system 1036 utilizes a global positioning system (GPS) 1038 to record the position, speed, direction, and other parameters of the tow vessels 1022.

As illustrated, the global positioning system 1038 may utilize or work in cooperation with satellites 1052 which operate on a suitable communication protocol, e.g. VSAT communications. The VSAT communications may be used, among other things, to supplement VHF and UHF communications. The GPS information can be independent of the VSAT communications and may be input to processing system 1046 or other suitable processors to predict the future movement and position of the vessels 1022 based on real-time information. In addition to predicting future movements, the processing system 1046 also can be utilized to provide directions and coordinates as well as to determine initial shot times, as described above. Control system 1034 effectively utilizes processing system 1046 in cooperation with source controller 1042 and synchronization unit 1044 to synchronize the sources 1024 with the downhole data acquisition system 1026.

As illustrated, the one or more vessels 1022 each tow one or more acoustic sources/source arrays 1024. The source arrays 1024 include one or more seismic signal generators 1054, e.g., air guns, configured to create a seismic/sonic disturbance. In the embodiment illustrated, the tow vessels 1022 comprise a master source vessel 1056 (Vessel A) and a slave source vessel 1057 (Vessel B). However, other numbers and arrangements of tow vessels 1022 may be employed to accommodate the parameters of a given seismic profiling application. For example, one source 1024 may be mounted at rig 1050 (see FIG. 10) or at another suitable location, and both vessels 1022 may serve as slave vessels with respect to the rig source 1024 or with respect to a source at another location.

However, a variety of source arrangements and implementations may be provided as desired for a given application. When utilizing dithered timing between the sources, for example, the master and slave locations of the sources can be adjusted according to the parameters of the specific seismic profiling application. In some applications, one of the source vessels 1022 (e.g., source vessel A in FIG. 10) may serve as the master source vessel while the other source vessel 1022 serves as the slave source vessel with dithered firing. However, an alternate source vessel 1022 (e.g., source vessel B in FIG. 10) may serve as the master source vessel while the other source vessel 1022 serves as the slave source vessel with dithered firing.

Similarly, the rig source 1024 may serve as the master source while one of the source vessels 1022 (e.g., vessel A) serves as the slave source vessel with dithered firing. The rig source 1024 also may serve as the master source while the other source vessel 1022 (e.g., vessel B) serves as the slave source vessel with dithered firing. In some applications, the rig source 1024 may serve as the master source while both of the source vessels 1022 serve as slave source vessels each with dithered firings. These and other arrangements may be used in achieving the desired synchronization of source 1024 with the downhole acquisition system 1026.

The acoustic receivers 1028 of data acquisition system 1026 may be deployed in borehole 1030 via a variety of delivery systems, such as wireline delivery systems, slickline delivery systems, and other suitable delivery systems. Although a single acoustic receiver 1028 could be used in the borehole 1030, the illustrated embodiment comprises a plurality of receivers 1028 that may be located in a variety of positions and orientations. The acoustic receivers 1028 may be configured for sonic and/or seismic reception. Additionally, the acoustic receivers 1028 may be communicatively coupled with processing equipment 1058 located downhole. By way of example, processing equipment 1058 may comprise a telemetry system for transmitting data from acoustic receivers 1028 to additional processing equipment 1059 located at the surface, e.g., on the rig 1050 and/or vessels 1022.

Depending on the specifics of a given data communication system, examples of surface processing equipment 1059 may comprise a radio repeater 1060, an acquisition and logging unit 1062, and a variety of other and/or additional signal transfer components and signal processing components. The radio repeater 1060 along with other components of processing equipment 1059 may be used to communicate signals, e.g., UHF and/or VHF signals, between vessels 1022 and rig 1050 and to enable further communication with downhole data acquisition system 1026.

It should be noted the UHF and VHF signals can be used to supplement each other. In general, the UHF band supports a higher data rate throughput but can be susceptible to obstructions and has less range. The VHF band is less susceptible to obstructions and has increased radio range but its data rate throughput is lower. In FIG. 10, for example, the VHF communications are illustrated as “punching through” an obstruction in the form of a production platform.

In some applications, the acoustic receivers 1028 are coupled to surface processing equipment 1059 via a hardwired connection. In other embodiments, wireless or optical connections may be employed. In still other embodiments, combinations of coupling techniques may be employed to relay information received downhole via the acoustic receivers 1028 to an operator and/or control system, e.g., control system 1034, located at least in part at the surface.

In addition to providing raw or processed data uphole to the surface, the coupling system, e.g. downhole processing equipment 1058 and surface processing equipment 1059, may be designed to transmit data or instructions downhole to the acoustic receivers 1028. For example, the surface processing equipment 1059 may comprise synchronization unit 1044 which coordinates the firing of sources 1024, e.g. dithered (delayed) source arrays, with the acoustic receivers 1028 located in borehole 1030. According to one embodiment, the synchronization unit 1042 uses coordinated universal time to ensure accurate timing. In some cases, the coordinated universal time system 1040 is employed in cooperation with global positioning system 1038 to obtain UTC data from the GPS receivers of GPS system 1038.

FIG. 10 illustrates one example of a system for performing seismic profiling that can employ simultaneous or near-simultaneous acquisition of seismic data. By way of example, the seismic profiling may comprise three-dimensional vertical seismic profiling but other applications may utilize rig/offset vertical seismic profiling or seismic profiling employing walkaway lines. An offset source can be provided by a source 1024 located on rig 1050, on a stationary vessel 1022, and/or on another stationary vessel or structure.

As an example, the overall seismic system 1020 may employ various arrangements of sources 1024 on vessels 1022 and/or rig 1050 with each location having at least one source/source array 1024 to generate acoustic source signals. The acoustic receivers 1028 of downhole acquisition system 1026 are configured to receive the source signals, at least some of which are reflected off a reflection boundary 1064 located beneath a sea bottom. The acoustic receivers 1028 generate data streams that are relayed uphole to a suitable processing system, e.g., processing system 1046, via downhole telemetry/processing equipment 1058.

While the acoustic receivers 1028 generate data streams, the navigation system 1036 determines a real-time speed, position, and direction of each vessel 1022 and also estimates initial shot times accomplished via signal generators 1054 of the appropriate source arrays 1024. The source controller 1042 may be part of surface processing equipment 1059 (located on rig 1050, on vessels 1022, or at other suitable locations) and is designed to control firing of the acoustic source signals so that the timing of an additional shot time (e.g. a shot time via slave vessel 1057) is based on the initial shot time (e.g. a shot time via master vessel 1056) plus a dither value.

The synchronization unit 1044 of, for example, surface processing equipment 1059, coordinates the firing of dithered acoustic signals with recording of acoustic signals by the downhole acquisition system 1026. Processor system 1046 is configured to separate a data stream of the initial shot and a data stream of the additional shot via the coherency filter 1048. As discussed above, however, other embodiments may employ pure simultaneous acquisition and/or may not perform separation of the data streams. In such cases, the dither is effectively zero.

After an initial shot time at T=0 (TO) is determined, subsequent firings of acoustic source arrays 1024 may be offset by a dither. The dithers can be positive or negative and sometimes are created as pre-defined random delays. Use of dithers facilitates the separation of simultaneous or near-simultaneous data sets to simplify the data processing. The ability to have the acoustic source arrays 1024 fire in simultaneous or near-simultaneous patterns reduces the overall amount of time used for three-dimensional vertical seismic profiling source acquisition. This, in turn, reduces rig time. As a result, the overall cost of the seismic operation is reduced, rendering the data intensive process much more accessible.

If the acoustic source arrays used in the seismic data acquisition are widely separated, the difference in move-outs across the acoustic receiver array of the wave fields generated by the acoustic sources 1024 can be sufficient to obtain a clean data image via processing the data without further special considerations. However, even when the acoustic sources 1024 are substantially co-located in time, data acquired by any of the methods involving dithering of the firing times of the individual sources 1024 described herein can be processed to a formation image leaving hardly any artifacts in the final image. This is accomplished by taking advantage of the incoherence of the data generated by one acoustic source 1024 when seen in the reference time of the other acoustic source 1024.

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 100, FIG. 1), and/or through manual control by a user who may make determinations regarding whether a given step, action, template, or model has become sufficiently accurate.

Examples of methods to use the measurements of pressure wavefields generated by traditional sources (or by marine vibrators) to estimate the directional pressure gradient in the source direction are described herein. A similar idea can easily be generalized for the receiver side in some examples.

Examples of techniques such as those described herein enable sparser and more cost-effective acquisition geometry. Some examples could also enable legacy surveys to be re-processed to deliver better results. Moreover, some examples such as those described herein enable multi-channel interpolation in domains where it has not been possible before, enabling finer seismic processing results. Some examples of the techniques including those described herein enable a multitude of applications that can impact the way seismic data are acquired and/or processed. Some example applications of computed gradients using techniques are described herein. Other applications are contemplated by the present disclosure.

Some examples are directed to the calculation of the component of the gradient in the source crossline dimension. For some examples, this enables multi-channel interpolation across source lines and consequently could enable wider spacing across source-lines, which would imply shorter and cheaper surveys, also lower environmental impact survey design strategies could be used to maximize the advantages from source gradient. This could impact any kind of marine acquisition, for example, for ocean bottom nodes.

For some examples, crossline gradient can be calculated in the receivers' coordinates dimensions, also enabling multichannel interpolation along these dimensions. Further applications for data processing enable 3D receiver deghosting to be performed on originally aliased towed streamer data. Some examples of the techniques described herein enable 3D source deghosting to be performed on originally aliased towed streamer data or ocean bottom seismic data. Some examples enable significant improvement in attenuating shallow water multiples. Some examples enable reprocessing of legacy data, taking advantage of denser grids at either or both source and receiver side.

An example includes a data processing method to use seismic data to estimate one or more directional components in the receivers' coordinates dimensions, also enabling multichannel interpolation along these dimensions during seismic surveys. A similar method could be applied to receivers, such as that described herein.

In marine scenarios (towed streamer or ocean bottom seismic), a physical wavefield describing the gradient of the pressure on the source side cannot be generated with standard seismic source devices (that could be referred as monopole sources, or combinations of arrays of monopole sources). It could be theoretically possible to generate such wavefields if dipole sources existed. Emerging marine-vibrator source technology may enable generating a directional pressure gradient wavefield, but this could imply significantly higher costs for the surveys.

Examples, such as those described herein, include a method to use the measurements of pressure wavefields generated by traditional sources or other types of sources such as, for example, but not limited to, marine vibrators and other technologies, to estimate the gradient of the pressure in the spatial dimensions of the source coordinates. This method could also be used to generate the gradient of the pressure in the spatial dimensions of the source coordinates of other types wavefields, either measured (particle motion wavefield) or generated through processing (upgoing/downgoing pressure, primary reflections, Green functions, or others). In particular, examples, such as those described herein, enable estimating the gradient of the pressure in the spatial dimensions of the source coordinates where such gradient cannot be calculated by applying traditional gradient operators directly to measurements, and in particular in the crossline direction, which includes the space across different sail lines. Once obtained, the source side gradient can enable multi-channel interpolation of the main wavefield in the source domain.

In marine scenarios, multi-channel interpolation of seismic sources can enable surveys to deploy a 1 w density carpet of seismic sources, resulting in faster and cheaper surveys in the field, also with a reduced the environmental footprint. In marine scenarios, one or more seismic source devices are towed by a vessel and shot while the vessel sails along pre-selected paths, called source lines. Reducing the density of source lines can reduce the cost and the environmental impact of the acquisition. Multi-channel interpolation can enable a finer resolution of the answer products, enabling reprocessing of legacy data acquired with standard geometries and processed assuming the crossline source dimension is not sampled completely. Some examples include estimating the source-side gradient of the seismic wavefields to estimate physical magnitude by processing wavefields generated by standard seismic sources, or with marine vibrators not run as dipoles.

An example of a workflow includes using the low frequency components of the measured signals to calculate local directional slownesses. This can be done using a time-derivative/gradient ratio (TGR), or using alternative methods known to those skilled in the art such as, but not limited to, plane destruction filters. Using local directional slownesses and input measurements, the directional gradient of input measurements can be calculated. An application using the techniques described herein includes estimating the gradient of the wavefield in the source crossline dimension and using the gradient to enable multi-channel interpolation across seismic source lines. Some examples of the techniques described herein are compatible with simultaneous sources. For some examples, a method described herein to calculate the gradient of the seismic wavefield at its source in marine scenarios can be generalized to calculate the gradients of wavefields in other domains and from other types of surveys, such as, for example, ocean bottom seismic receivers, land seismic sources and/or receivers, and distributed acoustic sensing sources and/or receivers.

In towed streamers marine acquisitions, in addition to the pressure wavefields, receiver technology can measure the particle motion of the pressure wavefields, which describes the gradient of the pressure wavefield. While this technology exists, it typically involves considerably higher cost with respect to alternatives that do not measure the horizontal components of particle motion or gradients at receivers. In practice, in the industry of towed streamer marine acquisitions, the majority of measuring devices in use do not have the ability to measure the horizontal particle motion or gradient. Examples of the techniques described herein enable estimating the horizontal gradients for data collected using technologies incapable of measuring the horizontal particle motion.

In ocean bottom seismics, the receivers can measure the pressure wavefield and the three components of the particle motion, but the particle motion measured at the water-bottom is not a direct measure of the gradient of the pressure, for well known physical reasons. While advanced processing technologies can be used to convert the particle motions at seabed into the gradient of the pressure, these require the knowledge of the properties of the near-surface formations and a well-sampled wavefield. Also in this case, the ability to estimate the horizontal gradient from the hydrophone measurements can be beneficial.

Examples, such as those described herein, are based on the following mathematical relations:

$$\frac{\partial P ( t , {x}_{S} , {y}_{S} )}{\partial {x}_{S}} = {p}_{{x}_{S}} ( t , {x}_{S} , {y}_{S} ) \frac{dP ( t , {x}_{S} , {y}_{S} )}{dt} \qquad Eq . ( 1 a )$$

$$\frac{\partial P ( t , {x}_{S} , {y}_{S} )}{\partial {y}_{S}} = {p}_{{y}_{S}} ( t , {x}_{S} , {y}_{S} ) \frac{dP ( t , {x}_{S} , {y}_{S} )}{dt} \qquad Eq . ( 1 b )$$

where the upper capital P indicates the pressure wavefield, described here as a function of time, t and the horizontal coordinates of the source (x_{S}, y_{S}), and pₓ_{_{S}} and p_{y}_{_{S}} describe the slowness of the wavefield along the directions x_{S} (Eq. (1a)), and y_{S} (Eq. (1b)), respectively, also as a function of time, and source horizontal coordinates. The dependency of terms from other variables such as the receiver coordinates, or the depth of the sources, amongst others is omitted in the description herein for simplicity. The same formulation can be extended to a higher dimensionality. Replacing the measured pressure wavefield P with any other wavefield that can be associated with the same coordinates, the same relations hold. Such wavefields could be the up-down separated wavefields in ocean-bottom acquisitions, or the particle velocity eventually measured by the receivers, for example. The pressure wavefield is used in this description. x is the in-line direction, indicating the direction along which the vessel sails, and y the crossline direction, across different sailing lines. The crossline direction in Eq. (1b) is described herein, but the same can be extended to the in-line direction, or be multi-dimensional.

Eq. (1b) indicates that if the crossline component of the slowness in the source crossline direction is known, then the crossline component of the gradient of the wavefield in the source direction can be calculated simply by multiplying the slowness by the time derivative of the pressure wavefield.

A method includes determining the slowness from the ratio of spatial derivatives and time derivatives that exploit the same relation described in Eq. (1a) and Eq. (1b). This method requires the spatial gradient of pressure to be either measured or calculated from the pressure. Alternative methods exist. In particular, such alternative methods estimate the slowness of seismic images. These methods, as well as others, can rely on well sampled data.

Seismic wavefields are often non-dispersive waves, especially in marine scenarios, and in non-dispersive waves the slowness does not vary with frequency. In nature dispersive waves exist, and in seismic measurements these can be treated as superficial waves, guided waves and other near-surface effects. Some example techniques described herein are based on an assumption that events are not dispersive, which is a good assumption for reflected seismic wavefields. This so-called “linearity assumption” is used to overcome some limitations due to spatial aliasing or poor sampling. When this assumption does not hold, the method can still be applied, with a possible accuracy reduction at high frequency.

With this assumption, the techniques high-cut the pressure measurements at a frequency “low-enough” that the remaining signal is not aliased along the crossline source direction or that at least it can be de-aliased with single-channel interpolation techniques. In fact, the seismic wavefield occupies a spatial bandwidth that is wider at high frequency, and depending on how coarse the sampling grid is, for some exemplary techniques, the maximum frequency that is not aliased is calculated. At very wide crossline spacing, “low enough” frequency may be too low to allow the filtered signal to have enough information, resolution or data quality (signal-to-noise ratio) to perform some operations described herein. In such cases, bandwidth enhancement technologies can be considered to estimate a slightly broader bandwidth low-frequency signal. Bandwidth enhancement technologies can be extended by a few hertz when the frequencies are extrapolated from very thin to very broad bandwidths. Some examples may use machine-learning techniques including those known in the art.

The low-frequency signal obtained in such a way could then be used to calculate a crossline gradient, as the crossline direction is not aliased, and its time derivative. Applying the relation in Eq. (1b) to these, we then get an estimate of the crossline slowness:

$${p}_{{y}_{S}} ( t , {x}_{S} , {y}_{S} ) = \frac{\partial {P}_{L F} ( t , {x}_{S} , {y}_{S} )}{\partial {y}_{S}} / \frac{{dP}_{L F} ( t , {x}_{S} , {y}_{S} )}{dt} \qquad Eq . ( 2 )$$

where LF indicates “low-frequency”.

Note that in Eq. (2), the subscript LF is used on the pressure wavefield P, but not on the slowness, as non-dispersive wavefields are where the slowness does not vary with frequency: p_{LF}=p. Once the estimate of the crossline component of the slowness is calculated by applying Eq. (2), the crossline component of the slowness can be multiplied by the time derivative of the full-band pressure, P, as indicated in Eq. (1b), to obtain the crossline component of the pressure gradient in the source direction. Depending on how data were measured, inline interpolation or regularization may be used.

For some examples, the assumption is that the local slowness of the wavefield described in Eq. (1a) and Eq. (1b) has the physical meaning of slowness of the propagation vector of the seismic events when the seismic wavefield includes a single event. If events with different propagation velocities overlap in time and space, the local apparent slowness of the resulting wavefield describes the physical slownesses of the cumulative wavefield at that particular instant in time and space. Where there are two events EV1 and EV2,

$$\frac{[ \frac{\partial {P}_{EV 1} ( t , {x}_{S} , {y}_{S} )}{\partial {y}_{S}} + \frac{\partial {P}_{EV 2} ( t , {x}_{S} , {y}_{S} )}{\partial {y}_{S}} ]}{[ \frac{d {P}_{EV 1} ( t , {x}_{S} , {y}_{S} )}{dt} + \frac{d {P}_{EV 2} ( t , {x}_{S} , {y}_{S} )}{dt} ]} \neq \frac{\frac{\partial {P}_{EV 1} ( t , {x}_{S} , {y}_{S} )}{\partial {y}_{S}}}{\frac{d {P}_{EV 1} ( t , {x}_{S} , {y}_{S} )}{dt}} + \frac{\frac{\partial {P}_{EV 2} ( t , {x}_{S} , {y}_{S} )}{\partial {y}_{S}}}{\frac{d {P}_{EV 2} ( t , {x}_{S} , {y}_{S} )}{dt}}$$

the left term describes the local slowness of the measured wavefield, while the right term describes the sum of the local slownesses of the individual events. If more events are present, some of them may not contain energy at high frequency, and the cumulative slowness of the whole wavefield at low frequency (Eq. (2)) may not describe accurately the cumulative slowness of the wavefield at higher frequencies, where fewer events are present. The use of the ratio of the gradients in Eq. (2) as an indicator of the physical slowness of the events in the wavefield can be based on a sparsity assumption. Data processing techniques that decompose the seismic signal in sets of sparse components include, but are not limited to, curvelet decomposition, set of complementary fan filters, and radon transforms. If the inline direction is well sampled, computing the crossline gradient can include
(a) Decompose the wavefield in a number N of wavefields by applying a set of N fan filters to original measurements. Each of the N wavefields contains energy confined in a limited range of inline velocities and events that are close to parallel in the inline direction. Being close to parallel at least in one direction can reduce the likelihood that the events overlap. Each of the N filters selects a narrow inline velocity range from the input. The N filters output N velocity ranges. The sum of the outputs of the fan filters returns the original input wavefield.
(b) For the narrow-inline-velocity-range wavefields, a low-pass filter can be executed in time up to a maximum frequency where the signal is not aliased, or that can be de-aliased in the crossline direction, or to a maximum frequency of choice below that value, and determining the crossline and the time derivatives of the low frequency wavefield in the selected inline velocity range.
(c) The crossline slownesses can be calculated using the formula in Eq. (2), using the crossline and the time derivatives of the low frequency inline velocity range wavefields calculated in (b). These are slownesses related to wavefields filtered in the N inline velocity ranges in point (a).
(d) The full-bandwidth time derivative of the wavefields in each inline velocity range obtained in (a) can be determined.
(e) The time derivative calculated in (d) can be multiplied by the slownesses calculated in (c) as indicated in Eq. (1b), to obtain the crossline gradients of the inline velocity range wavefields obtained in (a).
(f) The crossline gradients of the wavefields can be recombined in the inline velocity ranges obtained in (e) to obtain the crossline gradient of the overall input wavefield.

The time derivative calculated in (d) could be calculated in (b), before the low pass filter. This would prevent determining the time gradient twice. A similar consideration can be done with the order of the calculation of the time and space derivatives and the application of the fan filters. Due to linearity of the operators, the derivative of the fan filtered data is equivalent to the fan filtered derivative of the data.

With respect to the process in steps (a)-(f),
The fan filters sparsify the input wavefield. Other methods can be used.
The process operates along the source inline direction. Other directions are possible, such as the receiver inline.
Multi-dimensional filters can be considered for achieving a desired level of sparsity.
An interpolation step can be added before estimating slownesses.
A regularization term can be included in the calculation of slownesses with a ratio of traces.
The process can operate in inline radon domain (tau,p,y).
In the (t,x,y) domain or the inline radon domain (tau,p,y), the slownesses can be estimated by solving a L-norm inversion problem instead of applying Eq. (2).
In the (t,x,y) domain or the inline radon domain (tau,p,y), the slownesses can be estimated by solving a L-norm inversion problem, instead of applying Eq. (2) and a regularization constraint can be added.
   An alternative to the process in steps (a)-(f) above includes:
(a) Decompose the wavefield in a number N of wavefields by applying a set of N fan filters to original measurements. Each of the N wavefields contains energy confined in a limited range of inline velocities and events that are close to parallel in the inline direction. Being close to parallel at least in one direction can reduce the likelihood that the events overlap. Each of the N filters selects a narrow inline velocity range from the input. The N filters output N velocity ranges. The sum of the outputs of the fan filters returns the original input wavefield. Depending on survey design choices, in-line interpolation or regularization may be conducted prior to performing this step.
(b) For the narrow-inline-velocity-range wavefields, a low-pass filter can be executed in time up to a maximum frequency where the signal is not aliased or can be de-aliased by a single-channel interpolation technique, or to a maximum frequency of choice below that value.
(c) Each of the filtered panels can be interpolated in crossline.
(d) The crossline and the time derivatives of the low-frequency-and-narrow-inline-velocity-range wavefields can be calculated.
(e) The crossline slownesses can be calculated using the formula in Eq. (2) using the crossline and time derivatives of the low-frequency-and-narrow-inline-velocity-range wavefields calculated in (d).
(f) Outliers that are a product of the noise in the traces can be removed by executing a filter on the slownesses. The filter can include a median filter in either space or time, or another outlier removal tool. The resulting panels contain slownesses related to the narrow-inline-velocity-range wavefields filtered in step (a).
(g) The full-bandwidth time derivative of the narrow-inline-velocity range wavefields obtained in (a) can be calculated.
(h) The crossline gradients of the narrow-inline-velocity-range wavefields obtained in (a) are obtained by multiplying the time derivative calculated in (d) by the slownesses calculated in (e) as indicated in Eq. (1b).
(i) The crossline gradients of the narrow-inline-velocity-range wavefields obtained in (h) can be combined to obtain the crossline gradient of the overall input wavefield.

Another alternative includes the following:
(a) Decompose the wavefield in a number N of wavefields by applying a set of N fan filters to original measurements. Each of the N wavefields contains energy confined in a limited range of inline velocities and events that are close to parallel in the inline direction. Being close to parallel at least in one direction can reduce the likelihood that the events overlap. Each of the N filters selects a narrow inline velocity range from the input. The N filters output N velocity ranges. The sum of the outputs of the fan filters returns the original input wavefield. Depending on survey design choices, in-line interpolation or regularization may be conducted prior to performing this step.
(b) For the narrow-inline-velocity-range wavefields, a low-pass filter can be executed in time up to a maximum frequency that is non-aliased in the crossline direction or can be de-aliased by a single-channel interpolation technique, or to a maximum frequency of choice below that value.
(c) Each of the filtered panels can be interpolated in crossline.
(d) The crossline and the time derivatives of the low-frequency-and-narrow-inline-velocity-range wavefields can be calculated.
(e) The crossline slownesses can be calculated using another formulation of the ratio in Eq. (2), using the crossline and the time derivatives of the low-frequency-and-narrow-inline-velocity-range wavefields calculated in (d).

$${\tilde{p}}_{{y}_{S}} ( t , {x}_{S} , {y}_{S} ) = [ \frac{\partial {P}_{L F} ( t , {x}_{S} , {y}_{S} )}{\partial {y}_{S}} * \frac{{dP}_{L F} ( t , {x}_{S} , {y}_{S} )}{dt} ] / [ {( \frac{{dP}_{L F} ( t , {x}_{S} , {y}_{S} )}{dt} )}^{2} + {ε}^{2} ] \qquad Eq . ( 2 a )$$

where ε is a white noise term to stabilize the ratio.
(f) Outliers derived by the presence of noise in the traces can be removed by executing a filter on the slownesses. Such filter could be a median filter in either space or time, or other outlier removal tool. The resulting panels contain slowness estimates related to the narrow-inline-velocity-range wavefields filtered in point (a).
(g) The full-bandwidth time derivative of the narrow-inline-velocity range wavefields obtained in (a) can be calculated.
(h) The crossline gradients of the narrow-inline-velocity-range wavefields obtained in (a) can be obtained by multiplying the time derivative calculated in (d) by the slowness estimates calculated in (f) as indicated in Eq. (1b).
(i) The crossline gradient of the overall input wavefield can be obtained by recombining the crossline gradients of the narrow-inline-velocity-range wavefields obtained in (h).

Yet another alternative includes the following:
(a) The data from the time (t), inline (x), crossline (y) dimensions, in the intercept time (tau), inline-slowness (px) and crossline (y) domain can be transformed by performing a Radon transform of the data along the inline direction. Common slowness traces can be selected for any crossline.
(b) For any of these common-inline-slowness data, a low-pass filter in time up to maximum frequency that is non-aliased or that can be de-aliased in the crossline direction with a single-channel interpolator, or to a maximum frequency of choice below that value can be executed.
(c) Each of the filtered panels can be interpolated in crossline.
(d) The crossline and the time derivatives of the so obtained low-frequency-and-narrow-inline-velocity-range wavefields can be calculated.
(e) The crossline slownesses can be calculated using another formulation of the ratio described in Eq. (2) using the crossline and the time derivatives of the low-frequency-and-narrow-inline-velocity-range wavefields calculated in (c).

$${\tilde{p}}_{{y}_{S}} ( tau , p , {y}_{S} ) = [ \frac{\partial {P}_{L F} ( tau , p , {y}_{S} )}{\partial {y}_{S}} * \frac{{dP}_{L F} ( tau , p , {y}_{S} ) )}{dt} ] / [ {( \frac{{dP}_{L F} ( tau , p , {y}_{S} ) )}{dt} )}^{2} + {ε}^{2} ] \qquad Eq . ( 2 b )$$

where ε is a white noise term to stabilize the ratio.
(f) Outliers derived by the presence of noise in the traces can be removed by executing a filter on the slownesses. Such filter could be a median filter in either space or time, or other outlier removal tool. The resulting panels contain slownesses related to the narrow-inline-velocity-range wavefields filtered in point (a).
(g) The full-bandwidth time derivative of the narrow-inline-velocity range wavefields obtained in (a) can be calculated.
(h) The crossline gradients of to the narrow-inline-velocity-range wavefields obtained in (a) can be obtained by multiplying the time derivative calculated in (d) by the slownesses calculated in (c) as indicated in Eq. (1b).
(i) The crossline gradient of the overall input wavefield can be obtained by recombining the crossline gradients of the narrow-inline-velocity-range wavefields obtained in (h).

Another alternative includes replacing
(e) The crossline slownesses can be calculated using another formulation of the ratio in Eq. (2), using the crossline and the time derivatives of the low-frequency-and-narrow-inline-velocity-range wavefields calculated in (d).

$${{\tilde{p}}_{y}}_{S} ( t , {x}_{S} , {y}_{S} ) = [ \frac{\partial {P}_{L F} ( t , {x}_{S} , {y}_{S} )}{\partial {y}_{S}} * \frac{{dP}_{L F} ( t , {x}_{S} , {y}_{S}}{dt} ] / [ {( \frac{{dP}_{L F} ( t , {x}_{S} , {y}_{S}}{dt} )}^{2} + {ε}^{2} ] \qquad Eq . ( 2 a )$$

where ε is a white noise term to stabilize the ratio.
   with:
(e) The crossline slownesses can be calculated using the crossline and the time derivatives of the low-frequency-and-narrow-inline-velocity-range wavefields calculated in (c) by resolving the following inverse problem:

$${{\tilde{p}}_{y}}_{S} ( t , {x}_{S} , {y}_{S} ) = {{min}_{{{p}_{y}}_{S} ( t , {x}_{S} , {y}_{S} )} [ \frac{\partial {P}_{L F} ( t , {x}_{S} , {y}_{S} )}{\partial {y}_{S}} - {p}_{{y}_{S}} ( t , {x}_{S} , {y}_{S} ) \frac{{dP}_{L F} ( t , {x}_{S} , {y}_{S} )}{dt} ]}_{L} \qquad Eq . ( 2 c )$$

where L indicates the norm of the cost function.

Another alternative includes replacing
(e) The crossline slownesses can be calculated using another formulation of the ratio in Eq. (2), using the crossline and the time derivatives of the low-frequency-and-narrow-inline-velocity-range wavefields calculated in (d).

$${{\tilde{p}}_{y}}_{S} ( t , {x}_{S} , {y}_{S} ) = [ \frac{\partial {P}_{L F} ( t , {x}_{S} , {y}_{S} )}{\partial {y}_{S}} * \frac{{dP}_{L F} ( t , {x}_{S} , {y}_{S} )}{dt} ] / [ {( \frac{{dP}_{L F} ( t , {x}_{S} , {y}_{S} )}{dt} )}^{2} + {ε}^{2} ] \qquad Eq . ( 2 a )$$

where ε is a white noise term to stabilize the ratio.
   with:
(e) The crossline slownesses can be calculated using the crossline and the time derivatives of the low-frequency-and-narrow-inline-velocity-range wavefields calculated in (c) by resolving the following inverse problem:

$${{\tilde{p}}_{y}}_{S} ( t , {x}_{S} , {y}_{S} ) = {{min}_{{{p}_{y}}_{S} ( t , {x}_{S} , {y}_{S} )} [ \frac{\partial {P}_{L F} ( t , {x}_{S} , {y}_{S} )}{\partial {y}_{S}} - {p}_{{y}_{S}} ( t , {x}_{S} , {y}_{S} ) \frac{{dP}_{L F} ( t , {x}_{S} , {y}_{S} )}{dt} ]}_{L} + Fn [ {p}_{{y}_{S}} ( t , {x}_{S} , {y}_{S} ) ] \qquad Eq . ( 2 d )$$

where L indicates the norm of the cost function and Fn[p_{y}_{_{S}}(t, x_{S}, y_{S})] is a regularization term that can constrain the estimates slowness by maximizing its smoothness, its sparsity, or by controlling the distribution of its amplitudes. Slownesses in Eq. (2) or (2a) can be calculated using plane wave destruction (PWD) filters.

The multi-channel interpolation by matching pursuit (MIMAP) technique is focused on the receiver side in marine acquisitions where receivers are deployed along towed streamers. The method can interpolate multi-channel data sampled regularly or irregularly. For some examples described herein, the MIMAP technology is applied to interpolate along different directions, including the crossline source domain if both the wavefield and an estimate of its gradient along the direction of interest are available. For the exemplary technique described herein, MIMAP can be used in the source domain, and, for example, in the crossline direction.

Other methods (besides MIMAP) can be formulated by those skilled in the art to accommodate the multichannel scenario interpolation techniques for both regular and irregular grids. For example, a seismic deghosting solver that has a sparsity constraint in its cost function, expressed as a L1-norm term can be used. Such a solver could be generalized for multichannel interpolation by minimizing the following cost function.

$$χ ( u ) = {\vert {W}_{P} [ S u - P ] \vert}^{2} + {{W}_{Y} [ S \frac{\partial u}{\partial y} - Y ]}^{2} + {λ}_{L 1} {\vert u \vert}^{1} \qquad Eq . ( 3 )$$

where:
u: desired interpolated wavefield
S: inverse transform from sparsity promoting domain (e.g., Radon)
P: pressure measurement
Y: crossline component of the gradient of pressure, calculated in (f)
y: crossline direction
W_{P}, W_{Y}: weight matrices (to compensate for different distribution of energy or signal-to-noise ratio)
λ_{L1}: weight for sparsity constraint

A multistage version of MIMAP can also be used. The multistage MIMAP includes the steps of receiving pressure measurements in input, and applying a system and method in accordance with embodiments of the present disclosure to pressure measurements in input to estimate the gradients along one or more direction for the purpose of interpolating along a source crossline. The steps can also include executing MIMAP with pressure and gradient in input, selecting a portion of the interpolated wavefields that is reconstructed correctly and add it to the final output, subtracting the selected portion from the input pressure, with residual representing the input pressure for the next stage, and re-applying the system and method if exit conditions are not met.

In seismic acquisitions, multi-channel interpolation along the crossline direction of the source could allow either or both of increased quality of seismic processing results enabled by denser source carpets obtained through multi-channel interpolation, and reduced costs of seismic acquisition performed with less dense source lines and using multichannel interpolation to recover the same information of denser surveys. This could affect the way surveys are designed for ocean bottom seismic surveys.

A similar approach as the one described herein to calculate the gradients at the source could be applied also at the receiver side. This could enable multi-channel interpolation at the receiver, or even multi-dimensional multi-channel interpolation up to, for example, 5D (along both, source and receiver coordinates). In some configurations, estimating a crossline gradient at a receiver in towed streamer surveys can be performed.

What is described herein for the calculation of the crossline component of the gradient in the seismic source dimensions can be extended at the receiver dimensions, and in particular can be applied to the receivers in a towed streamer configuration. This could then provide the crossline gradient of the wavefield across streamers. The exemplary techniques described herein enable multi-channel interpolation on single-sensor streamers measuring the pressure wavefield. With respect to a multi-sensor streamer, measuring the vertical velocity, Vz, in addition to pressure, P, (e.g. using particle motion sensors in addition to hydrophones), these techniques described herein enable joint interpolation and deghosting as described herein. With respect to a multi-sensor streamer, when measuring the velocity vector, Vz, Vx and Vy, Vz, in addition to pressure, P, the system and method described herein can be used to supply information that may enable control of the quality of the measurements, and/or enable attenuation of noise in the particle velocity measurements.

A system and method in accordance with embodiments of the present disclosure enable joint interpolation and deghosting technology described in U.S. Pat. No. 9,030,910 to be performed in the source dimensions if the vertical component of the gradient of the wavefield is available in the source direction. A system and method in accordance with embodiments of the present disclosure enable 3D deghosting to be performed at a receiver on originally aliased towed streamer data, even if acquired with hydrophone-only streamers.

A system and method in accordance with embodiments of the present disclosure enable 3D deghosting in the source dimension in marine acquisition, for example, towed streamer or ocean bottom. The deghosting capability may be merged with the multi-channel interpolation functionality described in Eq. (3). 3D deghosting can be achieved by minimizing the cost function:

$$χ ( u ) = {\vert {W}_{P} [ S u ( 1 - G ( Δ t ) ) - P ] \vert}^{2} + {\vert {W}_{Y} [ S \frac{\partial u}{\partial y} ( 1 - G ( Δ t ) ) - Y ] \vert}^{2} + {λ}_{L 1} {\vert u \vert}^{1} + μ {\vert Δ t \vert}^{2} \qquad Eq . ( 4 )$$

where:
G(Δt): delay operator describing the delay of the ghost reflection as a function of the angle of incidence (or slowness)
Δt: time perturbation of the ghost model
μ: weight to constrain the perturbation of ghost delay

A system and method in accordance with embodiments of the present disclosure enable the attenuation of shallow water multiples in towed streamer and ocean bottom surveys. The processing technology used to model shallow water multiples can use dense carpets of sources and receivers in some examples. Such dense carpets of sources and receivers can be obtained using multi-channel interpolation enabled by the directional gradients using a system and method in accordance with embodiments of the present disclosure.

Other processing technologies that benefit from multi-channel interpolation (or joint interpolation and deghosting) enabled by a system can method in accordance with embodiments of the present disclosure include, but are not limited to, Up/Down deconvolution (UDD), and in particular in shallow scenarios multi-dimensional deconvolution (MDD).

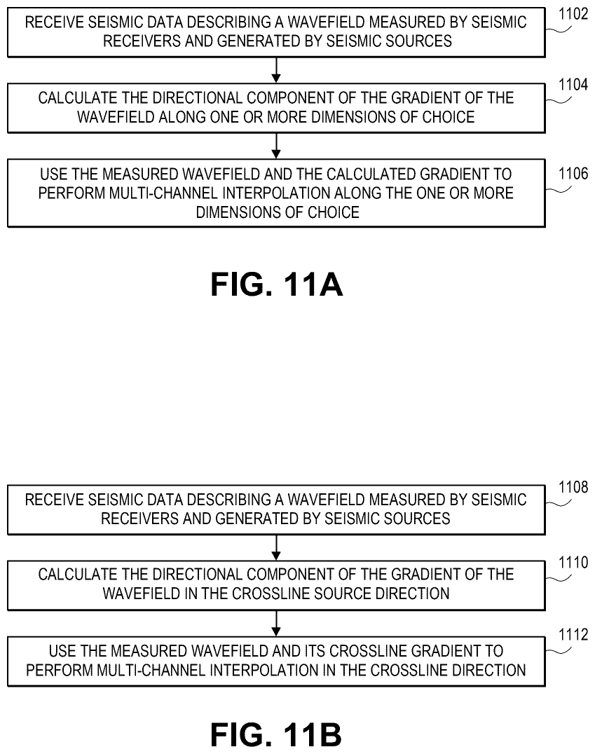

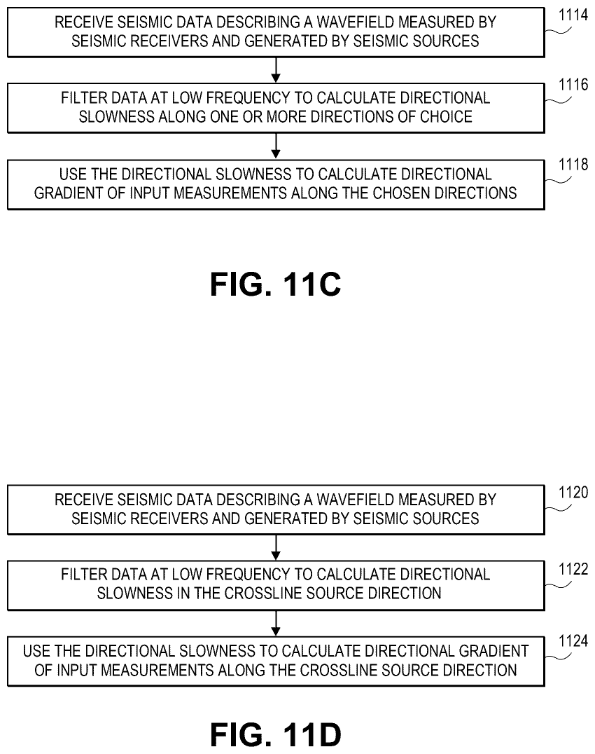

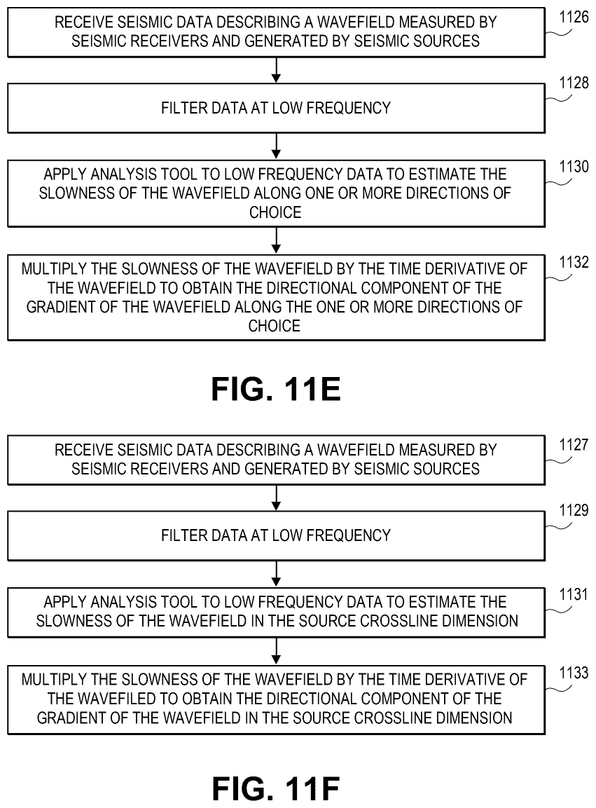

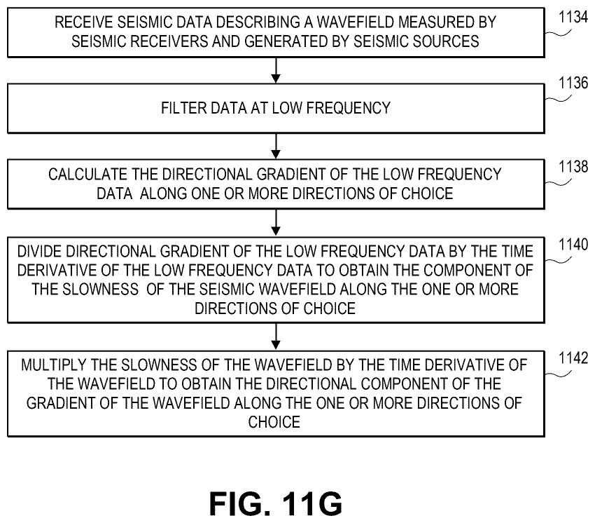

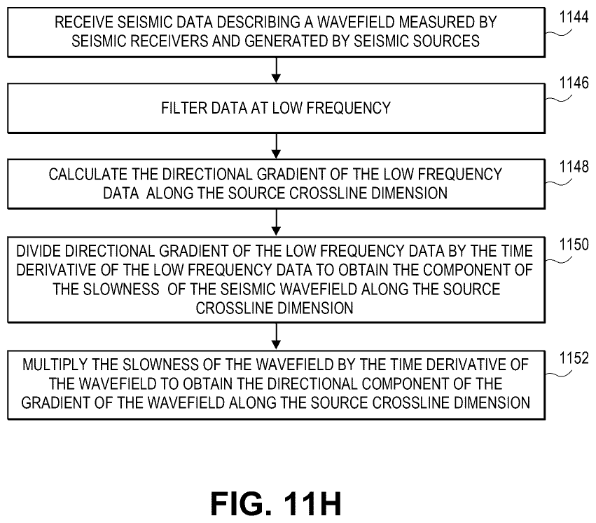

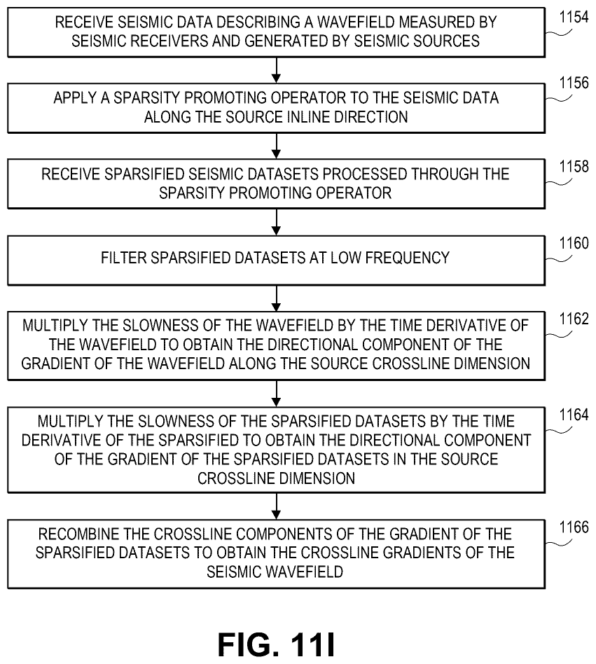

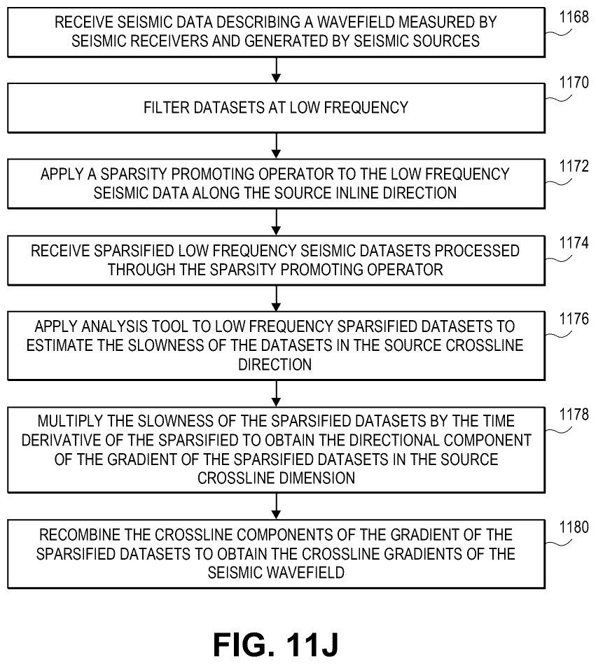

FIG. 11A is a method according to embodiments of the present disclosure. The method includes receiving 1102 seismic data describing a wavefield measured by seismic receivers and generated by seismic sources, calculating 1104 the directional component of the gradient of the wavefield along one or more dimensions of choice, and using 1106 the measured wavefield and the calculated gradient to perform multi-channel interpolation along the one or more dimensions of choice.

FIG. 11B is a method according to embodiments of the present disclosure. The method includes receiving 1108 seismic data describing a wavefield measured by seismic receivers and generated by seismic sources, calculating 1110 the directional component of the gradient of the wavefield in the crossline source direction, and using 1112 the measured wavefield and its crossline gradient to perform multi-channel interpolation in the crossline direction.

FIG. 11C is a method according to embodiments of the present disclosure. The method includes receiving 1114 seismic data describing a wavefield measured by seismic receivers and generated by seismic sources, filtering 1116 data at low frequency to calculate directional slowness along one or more directions of choice, and using 1118 the directional slowness to calculate a directional gradient of input measurements along the chosen directions.

FIG. 11D is a method according to embodiments of the present disclosure. The method includes receiving 1120 seismic data describing a wavefield measured by seismic receivers and generated by seismic sources, filtering 1122 data at low frequency to calculate directional slowness in the crossline source direction, and using 1124 the directional slowness to calculate directional gradient of input measurements along the crossline source direction.

FIG. 11E is a method according to embodiments of the present disclosure. The method includes receiving 1126 seismic data describing a wavefield measured by seismic receivers and generated by seismic sources, filtering 1128 data at low frequency, applying 1130 an analysis tool to low frequency data to estimate the slowness of the wavefield along one or more directions of choice, and multiplying 1132 the slowness of the wavefield by the time derivative of the wavefield to obtain the directional component of the gradient of the wavefield along one or more directions of choice.

FIG. 11F is a method according to embodiments of the present disclosure. The method includes receiving 1127 seismic data describing a wavefield measured by seismic receivers and generated by seismic sources, filtering 1129 data at low frequency, applying 1131 an analysis tool to low frequency data to estimate the slowness of the wavefield in the source crossline dimension, and multiplying 1133 the slowness of the wavefield by the time derivative of the wavefield to obtain the directional component of the gradient of the wavefield in the source crossline dimension.

FIG. 11G is a method according to embodiments of the present disclosure. The method includes receiving 1134 seismic data describing a wavefield measured by seismic receivers and generated by seismic sources, filtering 1136 data at low frequency, calculating 1138 the directional gradient of the low frequency data along one or more directions of choice, dividing 1140 the directional gradient of the low frequency data by the time derivative of the low frequency data to obtain the component of the slowness of the seismic wavefield along the one or more directions of choice, and multiplying 1142 the slowness of the wavefield by the time derivative of the wavefield to obtain the directional component of the gradient of the wavefield along the one or more directions of choice.

FIG. 11H is a method according to embodiments of the present disclosure. The method includes receiving 1144 seismic data describing a wavefield measured by seismic receivers and generated by seismic sources, filtering 1146 data at low frequency, calculating 1148 the directional gradient of the low frequency data along the source crossline dimension, dividing 1150 the directional gradient of the low frequency data by the time derivative of the low frequency data to obtain the component of the slowness of the seismic wavefield along the source crossline dimension, and multiplying 1152 the slowness of the wavefield by the time derivative of the wavefield to obtain the directional component of the gradient of the wavefield along the source crossline dimension.

FIG. 11I is a method according to embodiments of the present disclosure. The method includes receiving 1154 seismic data describing a wavefield measured by seismic receivers and generated by seismic sources, applying 1156 a sparsity promoting operator to the seismic data along the source inline direction, receiving 1158 sparsified seismic datasets processed through the sparsity promoting operator, filtering 1160 sparsified datasets at low frequency, multiplying 1162 the slowness of the sparsified datasets by the time derivative of the sparsified to obtain the directional component of the gradient of the sparsified datasets in the source crossline dimension, multiplying 1164 the slowness of the wavefield by the time derivative of the wavefield to obtain the directional component of the gradient of the wavefield along the source crossline dimension, and recombining 1166 the crossline components of the gradient of the sparsified datasets to obtain the crossline gradients of the seismic wavefield.

FIG. 11J is a method according to embodiments of the present disclosure. The method includes receiving 1168 seismic data describing a wavefield measured by seismic receivers and generated by seismic sources, filtering 1170 datasets at low frequency, applying 1172 a sparsity promoting operator to the low frequency seismic data along the source inline direction, receiving 1174 sparsified low frequency seismic datasets processed through the sparsity promoting operator, applying 1176 an analysis tool to low frequency sparsified datasets to estimate the slowness of the datasets in the source crossline direction, multiplying 1178 the slowness of the sparsified datasets by the time derivative of the sparsified datasets to obtain the directional component of the gradient of the sparsified datasets in the source crossline dimension, and recombining 1180 the crossline components of the gradient of the sparsified datasets to obtain the crossline gradients of the seismic wavefield.

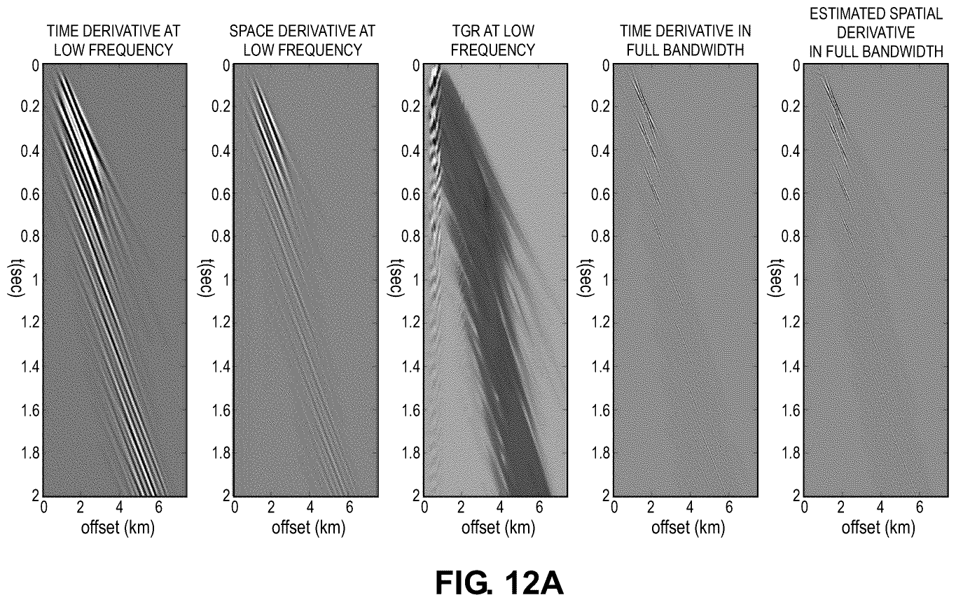

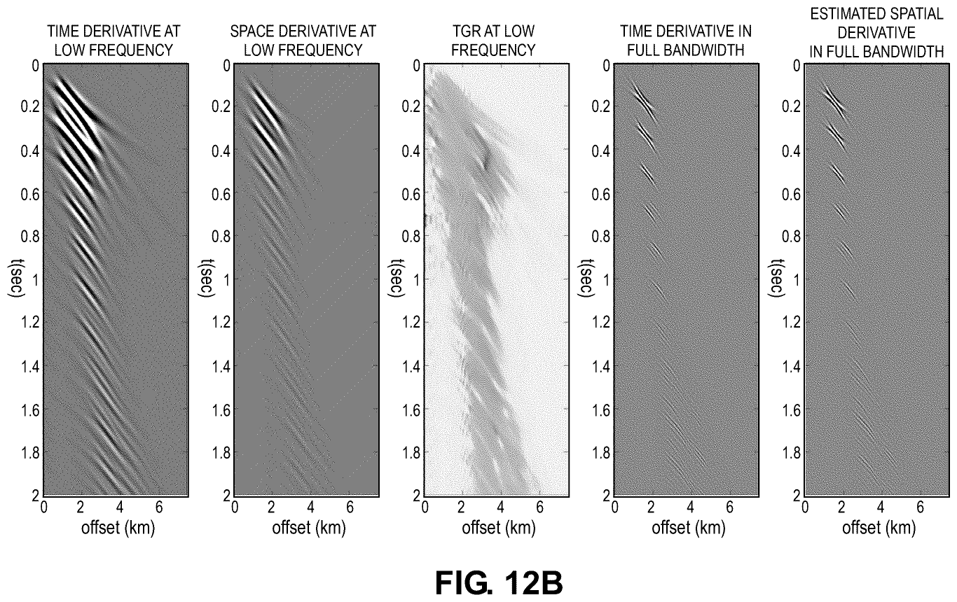

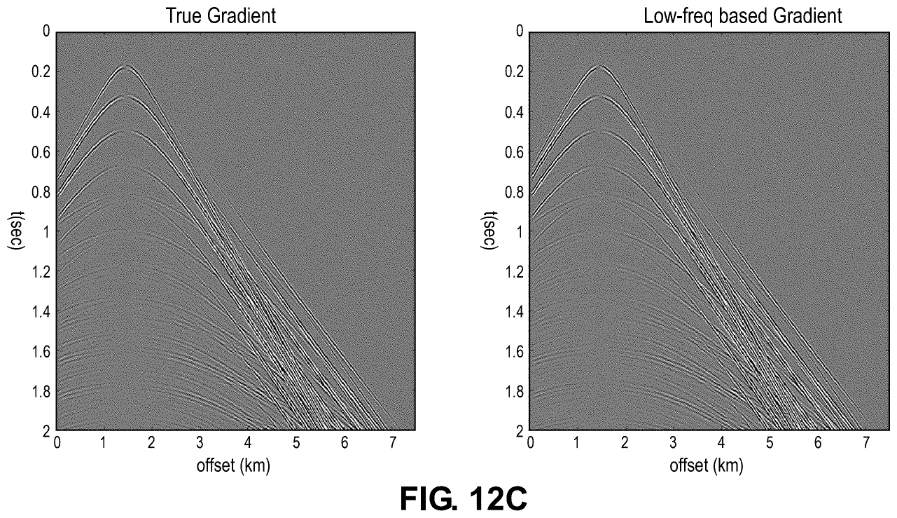

FIG. 12A illustrates an example of a method in accordance with embodiments of the present disclosure applied to data obtained by filtering seismic synthetic data in a narrow angular range. Low frequency data are filtered below 5 Hz. The same seismic synthetic data are filtered in other angular ranges to cover possible angles of incidence. The slowness visualized in the central panel is obtained as the ratio between the time and space derivatives shown on the left panels. The estimated spatial derivative shown in the right panel is obtained applying Eq. (1a), and multiplying the full bandwidth time derivative in the fourth panel with the slowness shown in the central panel, obtained with data below 5 Hz. This process is repeated for the outputs of the fan filters. For visual clarity, the examples in FIGS. 12A-12C are about data sampled along a single dimension (inline) and by consequence the gradients are calculated along the same dimension as the sparsifying operators (i.e., inline).

FIG. 12B illustrates an example of the algorithm applied to data obtained by filtering seismic synthetic data in a different angular range from the illustration in FIG. 12A.

FIG. 12C illustrates a modelled space derivative of synthetic seismic data (left panel), and an estimated space derivative of the seismic synthetic data, calculated using a method in accordance with embodiments of the present disclosure.

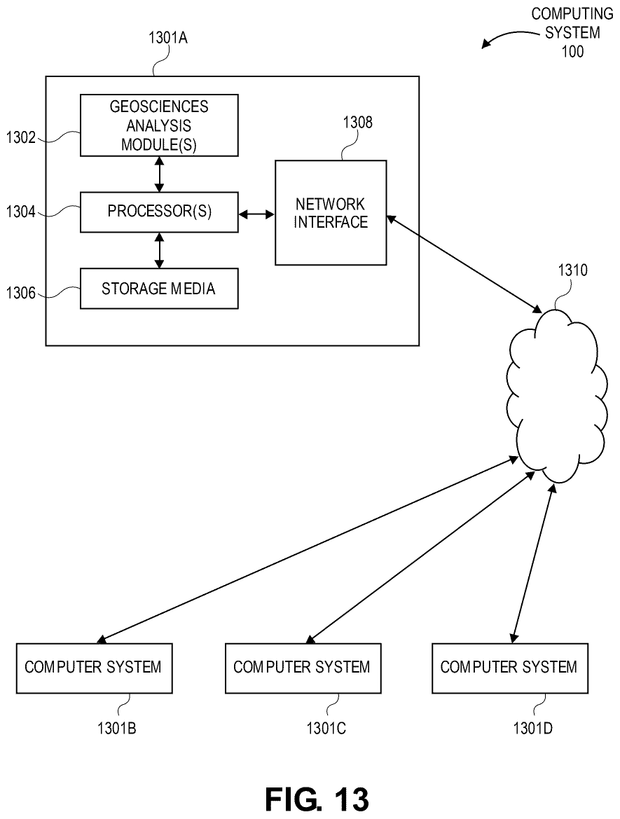

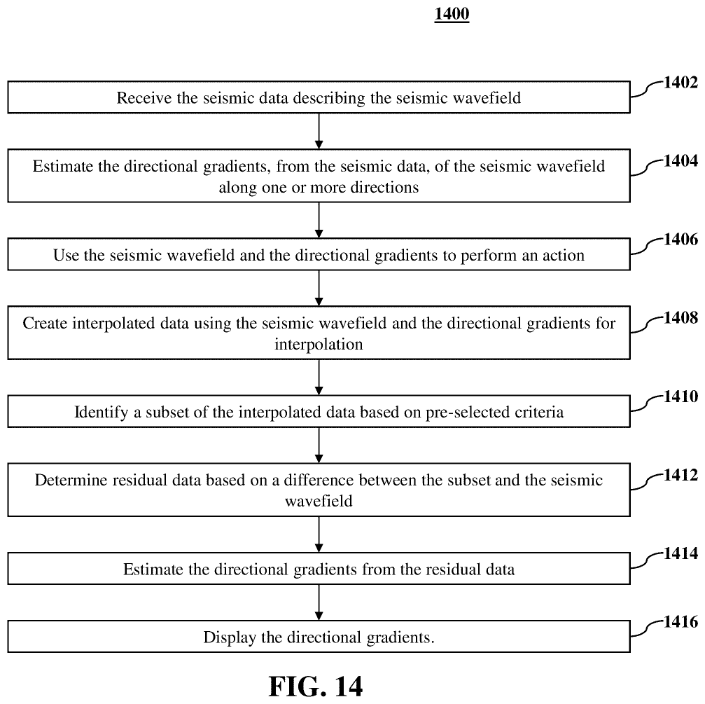

In some embodiments, the methods of the present disclosure may be executed by a computing system. FIG. 13 illustrates an example of such a computing system 100, in accordance with some embodiments. The computing system 100 may include a computer or computer system 1301A, which may be an individual computer system 1301A or an arrangement of distributed computer systems. The computer system 1301A includes one or more analysis modules 1302 that are configured to perform various tasks according to some embodiments, such as one or more methods disclosed herein. To perform these various tasks, the analysis module 1302 executes independently, or in coordination with, one or more processors 1304, which is (or are) connected to one or more storage media 1306. The processor(s) 1304 is (or are) also connected to a network interface 1307 to allow the computer system 1301A to communicate over a data network 1309 with one or more additional computer systems and/or computing systems, such as 1301B, 1301C, and/or 1301D (note that computer systems 1301B, 1301C and/or 1301D may or may not share the same architecture as computer system 1301A, and may be located in different physical locations, e.g., computer systems 1301A and 1301B may be located in a processing facility, while in communication with one or more computer systems such as 1301C and/or 1301D that are located in one or more data centers, and/or located in varying countries on different continents).

A processor may include a microprocessor, microcontroller, processor module or subsystem, programmable integrated circuit, programmable gate array, or another control or computing device.

The storage media 1306 may be implemented as one or more computer-readable or machine-readable storage media. Note that while in the example embodiment of FIG. 13 storage media 1306 is depicted as within computer system 1301A, in some embodiments, storage media 1306 may be distributed within and/or across multiple internal and/or external enclosures of computing system 1301A and/or additional computing systems. Storage media 1306 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 100 contains one or more network interface module(s) 1308. It should be appreciated that computing system 100 is merely one example of a computing system, and that computing system 100 may have more or fewer components than shown, may combine additional components not depicted in the example embodiment of FIG. 13, and/or computing system 100 may have a different configuration or arrangement of the components depicted in FIG. 13. The various components shown in FIG. 13 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 100, FIG. 13), and/or through manual control by a user who may make determinations regarding whether a given step, action, template, model, or set of curves has become sufficiently accurate for the evaluation of the subsurface three-dimensional geologic formation under consideration.

Method 1400, operable to estimate directional gradients of a seismic wavefield from seismic data from a seismic survey, includes receiving 1402 the seismic data describing the seismic wavefield. The seismic data include land seismic, towed steamer measurements, ocean bottom cables measurements, ocean bottom nodes measurements, and the seismic data at intermediate stages of seismic processing flows.

Method 1400 includes estimating 1404 the directional gradients, from the seismic data, of the seismic wavefield along one or more directions. estimating the directional gradients includes estimating slowness based on a time derivative of the seismic wavefield. Estimating the slowness includes pre-processing the seismic wavefield using any one of time-derivative/gradient ratio, resolving an inverse problem, or plane wave destruction filters. Pre-processing the seismic wavefield includes any one of applying a fan filter in inline to the seismic wavefield, transforming in a sparsity promoting domain, applying a low pass filter to the seismic wavefield, or applying a crossline interpretation to the seismic wavefield.

Method 1400 includes using 1406 the seismic wavefield and the directional gradients to perform an action. The action includes any one or more of interpolation or full waveform inversion using the seismic wavefield and the directional gradients. The interpolation includes any one of MIMAP or MC interpretation. The one or more directions includes any one of inline source or crossline source in ocean bottom node/towed streamer/land, or any one of inline receiver or crossline receiver in ocean bottom node/towed streamer/land, or any one of inline offset or crossline offset, or any one of inline midpoint or crossline midpoint, or any one of depth model space and intermediate domain during processing. The action includes designing the seismic survey, or reprocessing historical seismic data.

In another embodiment, the action may be or include generating and/or transmitting a signal (e.g., using a computing system) that recommends, instructs, or causes a physical action to occur at a wellsite. The action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

Method 1400 includes creating 1408 interpolated data using the seismic wavefield and the directional gradients for interpolation.

Method 1400 includes identifying 1410 a subset of the interpolated data based on pre-selected criteria.

Method 1400 includes determining 1412 residual data based on a difference between the subset and the seismic wavefield.

Method 1400 includes estimating 1414 the directional gradients from the residual data.

Method 1400 includes displaying 1416 the directional gradients.

Many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Many examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

Those with skill in the art will appreciate that while the quoted sections of the article above that are provided for illustrative purposes include terms that could be interpreted as potentially absolute or requiring a given thing (including without limitation “exactly”, “exact”, “only”, “key”, “important”, “requires”, “all”, “each”, “must”, “always”, etc.), the various systems, methods, processing procedures, techniques, and workflows disclosed herein are not to be understood as limited by the use of these terms

In some embodiments, the multi-dimensional region of interest is selected from the group consisting of a subterranean region, human tissue, plant tissue, animal tissue, solid volumes, substantially solid volumes, volumes of liquid, volumes of gas, volumes of plasma, and volumes of space near and/or outside the atmosphere of a planet, asteroid, comet, moon, or other body.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

1. A method for estimating directional gradients of a seismic wavefield from seismic data from a seismic survey, the method comprising:
receiving the seismic data describing the seismic wavefield;
estimating the directional gradients of the seismic wavefield from the seismic data along one or more directions; and
using the seismic data and the estimates of the directional gradients to perform an action.

2. The method of claim 1, wherein estimating the directional gradients comprises:
estimating local directional slowness of the seismic wavefield from the seismic data; and
calculating the directional gradients based on the estimated local directional slowness and a time derivative of the seismic data.

3. The method of claim 2, wherein estimating the local directional slowness comprises:
using any one solution including time-derivative/gradient ratio, resolving an inverse problem, or plane wave destruction filters, or machine learning applications.

4. The method of claim 1, further comprising:
pre-processing the seismic data including one or more of applying a fan filter in inline to the seismic data, transforming the seismic data in a sparsity promoting domain, applying a low pass filter to the seismic data, and applying a crossline interpretation to the seismic data.

5. The method of claim 1, wherein the action comprises:
any one or more of interpolation or full waveform inversion using the seismic data and the directional gradients.

6. The method of claim 5, wherein the interpolation comprises:
any one of multi-channel interpolation by matching pursuit (MIMAP) technique or multi-channel interpretation.

7. The method of claim 5, further comprising:
(a) receiving the seismic wavefield at a first iteration or as residual data from previous iterations;
(b) estimating the directional gradients of the seismic data;
(c) creating interpolated data by applying a multi-channel interpolation technique to the received seismic wavefield and the estimated directional gradients;
(d) identifying a subset of the interpolated data based on pre-selected criteria;
(e) adding the identified subset of the interpolated data to a final output;
(f) determining the residual data based on a difference between the identified subset and the received seismic wavefield;
(g) evaluating exit conditions and, if not met, repeat steps (a)-(f); and
(h) repeating steps (a)-(g) until predetermined criteria are verified.

8. The method of claim 1, wherein the one or more directions comprises:
a crossline source in ocean bottom node/towed streamer/land.

9. The method of claim 1, wherein the one or more directions comprises:
a crossline receiver in ocean bottom node/towed streamer/land.

10. The method of claim 1, wherein the one or more directions comprises:
a crossline offset.

11. The method of claim 1, wherein the one or more directions comprises:
a crossline midpoint.

12. The method of claim 1, wherein the one or more directions comprises:
any one of depth model space or intermediate domain during processing.

13. The method of claim 1, wherein the action comprises:
designing the seismic survey.

14. The method of claim 1, wherein the action comprises:
reprocessing historical seismic data.

15. A computing system, comprising:
one or more processors; and
a memory system comprising one or more non-transitory computer-readable media storing instructions that, when executed by at least one of the one or more processors, cause the computing system to perform operations for operable to estimate directional gradients of a seismic wavefield from seismic data from a seismic survey, the operations comprising:
receiving the seismic data describing the seismic wavefield;
estimating the directional gradients of the seismic wavefield from the seismic data along one or more directions; and
using the seismic data and the estimates of the directional gradients to perform an action.

16. The computing system of claim 15, wherein estimating the directional gradients comprises:
estimating local directional slowness of the seismic wavefield from the seismic data; and
calculating the directional gradients based on the estimated local directional slowness and a time derivative of the seismic data.

17. The computing system of claim 16, wherein estimating the local directional slowness comprises:
using any one solution including time-derivative/gradient ratio, resolving an inverse problem, or plane wave destruction filters, or machine learning applications.

18. The computing system of claim 17, wherein the one or more directions comprises:
a crossline source in ocean bottom node/towed streamer/land.

19. The computing system of claim 15, wherein the action comprises:
designing the seismic survey or reprocessing historical seismic data.

20. A non-transitory computer-readable medium storing instructions that, when executed by one or more processors of a computing system, cause the computing system to perform operations operable to estimate directional gradients of a seismic wavefield from seismic data from a seismic survey, the operations comprising:
receiving the seismic data describing the seismic wavefield, wherein the seismic data include land seismic, towed steamer measurements, ocean bottom cables measurements, ocean bottom nodes measurements, and the seismic data at intermediate stages of seismic processing flows;
estimating the directional gradients, from the seismic data, of the seismic wavefield along one or more directions, wherein estimating the directional gradients comprises estimating slowness based on a time derivative of the seismic wavefield, wherein estimating the slowness comprises pre-processing the seismic wavefield using any one of time-derivative/gradient ratio, resolving an inverse problem, or plane wave destruction filters, wherein pre-processing the seismic wavefield comprises any one of applying a fan filter in inline to the seismic wavefield, transforming in a sparsity promoting domain, applying a low pass filter to the seismic wavefield, or applying a crossline interpretation to the seismic wavefield;
using the seismic wavefield and the directional gradients to perform an action, wherein the action comprises any one or more of interpolation or full waveform inversion using the seismic wavefield and the directional gradients, wherein the interpolation comprises any one of MIMAP or MC interpretation, wherein the one or more directions comprises any one of inline source or crossline source in ocean bottom node/towed streamer/land, or any one of inline receiver or crossline receiver in ocean bottom node/towed streamer/land, or any one of inline offset or crossline offset, or any one of inline midpoint or crossline midpoint, or any one of depth model space and intermediate domain during processing, wherein the action comprises designing the seismic survey, or reprocessing historical seismic data;
creating interpolated data using the seismic wavefield and the directional gradients for interpolation;
identifying a subset of the interpolated data based on pre-selected criteria;
determining residual data based on a difference between the subset and the seismic wavefield;
estimating the directional gradients from the residual data; and
displaying the directional gradients.
